(19) United States
(12) Patent Application Publication
(10) Pub. No.: US 2006/0237864 A1
(43) Pub. Date: Oct. 26, 2006

(54) Method for producing optical film

(76) Inventors: Yoshikuni Morita, Osaka (JP); Yu Tsuyama, Osaka (JP); Keiichiro Tani, Osaka (JP); Tetsuro Taen, Osaka (JP); Taizo Yasumoto, Osaka (JP); Shuzo Ohara, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/552,478

(22) PCT Filed: Mar. 26, 2004
(86) PCT No.: PCT/JP04/04351

§ 371 Date: Oct. 7, 2005

(30) Foreign Application Priority Data
Apr. 10, 2003 (JP) 2003-106433
Dec. 5, 2003 (JP) 2003-407336

(51) Int. Cl. B29D 7/01

(52) U.S. Cl. 264/1.34

(57) ABSTRACT

A method for producing optical films is provided which comprises the steps of: melt-extruding a thermoplastic resin into a film through a die of an extruder, pressing the melt-extruded thermoplastic resin layer together with a supporting layer between a cooling roll which is made of metal or ceramic and a rubber roll which is pressed against the cooling roll and rolled in the same circumferential direction, carrying the thermoplastic resin layer together with the supporting layer under taking off tension until the thermoplastic resin layer is cooled down, and peeling and separating the supporting layer from the thermoplastic resin layer to obtain a thermoplastic resin film. Optical films are provided by a melt-extrusion method which have less optical surface defects such as die lines and gear marks and less fluctuations in film thickness and have uniform optical characteristics, which are useful as a material for various optical films used in liquid crystal displays, especially, a retardation film.

### TECHNICAL FIELD

The present invention relates to a method for producing optical films and more particularly to a method for producing optical films which have less fluctuations in thickness and excellent smoothness, and uniform optical characteristics throughout the entire surface.

### BACKGROUND ART

In recent years, optical films or optical sheets (hereinafter, referred to as films together) are widely used in a liquid crystal display unit. In a liquid crystal display unit, there are installed a film polarizer for generating polarization, a touch panel which is provided with a transparent electrodes on its surface, a plastic substrate which is an alternative to a glass substrate provided with transparent electrodes and a retardation plate to compensate an optical phase difference from retardation generated from a liquid crystal molecule.

In the film polarizer, a moisture-resistant protection film is bonded in order to protect the polarizer film from moisture in an example of oriented polyvinyl alcohol iodine-adsorption film. As such a protective film, a casting film of triacetyl cellulose is generally used. As a touch panel, panels formed by providing a transparent conductive layer on a film substrate are used, and biaxially oriented polyethylene terephthalate films are generally used. On these films, improvements in transparency, moisture resistance and birefringence are desired. Further, there is desired a plastic substrate which is an alternative to a glass substrate provided with transparent electrodes. For these applications as well as the retardation plate described below, various high polymer films are proposed.

Oriented optical films are employed for the retardation plate. These optical films have included high polymer films such as polycarbonate, polysulfone, polyallylate, polyphenylene sulfide, etc. And the retardation plate is obtained by monoaxially or biaxially drawing and orienting these high polymer films.

In recent years, there are required rationalizations and improvements in quality of the above-mentioned various optical films for liquid crystal display units. In order to obtain precise image of liquid crystal display, it is necessary in these optical films that first, throughout the entire film, residual stress is small, a retardation is low and its fluctuations are small, that second, there are not fluctuations in thickness and die lines since the phase difference is proportional to a thickness and a film thickness is equal to a desired thickness, and that third, naturally, film scratch defects, contamination of foreign matters and wrinkles must be avoided. And, films of cyclic polyolefin have been noted as an optical film since this film less causes birefringence when a molecule is oriented.

Previously, as a method for producing optical films there are proposed the following methods:

(1) A method in which a resin is dissolved in a solvent to form a solution, and after this solution is flown and spread onto an endless metal belt or a base film, the solvent is evaporated and removed to form a resin layer, and then this resin layer is peeled and separated from the endless metal belt or the base film, disclosed in Japanese Unexamined Patent Publication No. 4-301415; and

(2) A method of obtaining films by melt-extruding a resin into a film through a die by the use of an extruder and cooling down the extruded resin with a cooling roll, disclosed in Japanese Unexamined Patent Publication No. 4-118213, Japanese Unexamined Patent Publication No. 4-166319 and Japanese Unexamined Patent Publication No. 4-275129.

However, in the above method (1), it is difficult to thoroughly evaporate and remove the solvent and if there are variations in remaining solvent, this causes uneven stress in drawing and a uniform retardation plate cannot be realized. In order to obtain particular uniform quality, drying must start from a relatively low temperature and temperature must be raised gradually, and therefore when a processing speed is increased, an excessive drying unit is required and also a large amount of energy is required, and consequently production facility becomes expensive and running cost becomes high. Furthermore, a work environment may be deteriorated and it costs to maintain the work environment.

In the above method (2), a plurality of cooling rolls are often used, adhesion force of a resin to a metal roll is weak and therefore when the resin is cooled below about 50° C. between respective rolls, the resin loses an adhesion force to a roll and is peeled due to a volumetric change, and therefore shrinkage stress is produced and tensile stress remains. In order to avoid this, it is necessary to precisely control temperature, a rotational speed of a roll and amount of a bank, but it is difficult to maintain a constant residual stress. In addition, since residual stresses at both sides of a formed film due to the neck in from a die is particularly large, much trimming is necessary. In addition to this, the obtained film tends to cause fluctuations in thickness, die lines and gear marks, it is impossible to obtain a raw material film to be provided for optical uses.

In order to improve the defect of this melt-extrusion process, a method of pressing the melted resin discharged through a die of an extruder between a pair of rolls is proposed in Japanese Unexamined Patent Publication No. 2-61899. However, in accordance with this method, it is impossible to provide such a film that can be provided for optical uses, which has dissolved die lines, gear marks and fluctuations in thickness. Further, in the method of pressing between a pair of rolls, since there is only a control gap between crowns of rolls and operating conditions are subjected to constraints when a processing speed is fast, this method is insufficient for dissolving the above various fluctuations. In order to improve this defect, there is proposed a method of installing endless metal belts above and below the melted resin and pressing the melted resin between these belts in Japanese Unexamined Patent Publication No. 3-75110. But, even in this method, since pressing between rolls is performed only at a portion between rolls pressing the metal belts, adhesion of the resin to the metal belt is insufficient or a temperature gradient cannot be secured and therefore a uniform film is hard to obtain.

In order to improve a method of pressing between the endless metal belts, there are proposed many methods. For example, in the case of polypropylene, there is disclosed a method of combining one cast roll and one endless metal belt, and pressing the metal belt along the arc of the cast roll in Japanese Unexamined Patent Publication No. 6-170919 and Japanese Unexamined Patent Publication No. 6-166089. Further, based on this method, there are proposed a method of setting a cooling temperature at a temperature around a glass transition temperature of a extruded resin in Japanese Unexamined Patent Publication No. 9-239812, a method of setting a cooling temperature at a temperature above a glass transition temperature in Japanese Unexamined Patent Publication No. 2000-280268, a method of adjusting a take-up speed after being peeled off from a metal roll in Japanese Unexamined Patent Publication No. 9-290427 and a method of installing a peel roll in the vicinity of a cast roll in Japanese Unexamined Patent Publication No. 10-16034. Further, there is proposed a method of dissolving traces of peeling by adjusting a gap between an endless metal belt and a pressure roll on the peeling side in Japanese Unexamined Patent Publication No. 10-10321, but by this method, it is difficult to prevent a residual retardation and to attain uniform quality, and the cost of facility and operation become expensive.

On the other hand, as for a method of pressing between rolls, there are trials to enhance an effect of pressing between rolls changing from pressing between metals to pressing between metal and a rubber material. As one example of this trial, there is proposed a method of combining a pressing means such as a spring and a hydraulic piston in order to maintain a uniform gap between rolls, though not limited to a combination of a metal and a rubber material in Japanese Unexamined Patent Publication No. 2000-280315, but this method is unsatisfactory on characteristics of the film surface.

Further, there is known a method of transferring the surface of a film having mirror gloss through lamination and metal vapor depositing this surface in order to improve a surface property of extruded polyolefin on a base material in Japanese Unexamined Patent Publication No. 59-5056, but this method improves in gloss of a laminated paper based on paper, and does not suggest the production of optical films at all.

It is an object of the present invention to produce various optical films resolving the problems which the above conventional technology has and used for liquid crystal displays or the like, for example, optical films which are useful as a raw material of an optical film for retardation plates and are free from fluctuations in thickness such as die lines and gear marks and have uniform thickness and little residual retardation at low cost and with high productivity.

In view of such a state of the art, the present inventors have made an extensive series of studies to resolve the above issues, and consequently they have found that a desired optical film can be obtained by pressing a thermoplastic resin melt-extruded into a film through an extrusion die together with a supporting layer between a cooling roll which is made of metal or ceramic and a rubber roll, carrying the thermoplastic resin layer together with the supporting layer in a state of pseudo-bonding and then peeling off the supporting layer from the thermoplastic resin layer. Further, the present inventors have found the best operation for a cooling roll and a rubber roll in producing an optical film by the above method, leading to completion of the present invention.

### DISCLOSURE OF THE INVENTION

The invention concerning claim 1 of the present invention encompasses a method for producing optical films comprising the steps of

melt-extruding a thermoplastic resin into a film through a die of an extruder,

pressing the melt-extruded thermoplastic resin layer together with a supporting layer between a cooling roll which is made of metal or ceramic and a rubber roll which is pressed against the cooling roll and rolled in the same circumferential direction,

carrying the thermoplastic resin layer together with the supporting layer under taking off tension until the thermoplastic resin layer is cooled down, and

peeling and separating the supporting layer from the thermoplastic resin layer to obtain a thermoplastic resin film.

The invention concerning claim 2 of the present invention encompasses the method for producing optical films according to claim 1, wherein the distance of a gap between the cooling roll and the rubber roll is set so as to be any value between 10% and 90% of the total thickness of the supporting layer and the film, and a stopper is installed on either the cooling roll or the rubber roll in such a way that these two rolls does not come within a distance of this value of each other, and the thermoplastic resin layer is pressed between the rolls by applying a pressing force of 2.7 to 10.0 kgf/cm to the roll on which the stopper is provided.

The invention concerning claim 3 of the present invention encompasses the method for producing the optical films according to claim 1 or 2, wherein the supporting layer is a synthetic resin film.

The invention concerning claim 4 of the present invention encompasses the method for producing optical films according to any one of claims 1 to 3, wherein the rubber roll is a roll in which a rubber-like material having a surface hardness of 60 or more is wound around a metal core in a thickness of 5 to 15 mm.

The invention concerning claim 5 of the present invention encompasses the method for producing optical films according to any one of claims 1 to 4, wherein the thermoplastic resin layer is pressed through the supporting layer between rolls by arranging the supporting layer on the side contacting with a rubber roll.

The invention concerning claim 6 of the present invention encompasses the method for producing optical films according to any one of claims 1 to 4, wherein the thermoplastic resin layer is pressed through the supporting layers between rolls by arranging the supporting layers on one side contacting with a rubber roll and on the other side contacting with a cooling roll.

The invention concerning claim 7 of the present invention encompasses the method for producing optical films according to any one of claims 1 to 6, wherein the thermoplastic resin is a cyclic polyolefin resin.

The invention concerning claim 8 of the present invention encompasses the method for producing optical films according to any one of claims 1 to 7, wherein the supporting layer comprises a biaxially oriented polyethylene terephthalate.

The invention concerning claim 9 of the present invention encompasses the method for producing optical films according to any one of claims 1 to 8, wherein optical films obtained by the method for producing according to any one of claims 1 to 8 have the smoothness of 0.01 μm or less in terms of an average roughness Ra and a birefringence of 30 nm or less in terms of retardation.

The invention concerning claim 10 of the present invention encompasses the method for producing according to any one of claims 1 to 8, wherein optical films have a retardation of 20 nm or less, and the streaks or the pattern of tints are not substantially visually recognized when transmitted light of light impinged at an angle of 45 degrees to a film is projected on a vertical plane.

### BRIEF DESCRIPTION OF THE DRAWINGS

FIG. 1 is a schematic view in the case of arranging the supporting layer on one side of a melted resin and pressing the melted resin between rolls to produce optical films of the present invention.

FIG. 2 is a schematic view in the case of arranging the supporting layers on both sides of a melted resin and pressing the melted resin between rolls to produce optical films of the present invention.

FIG. 3 is a schematic view showing a structure of a stopper (cotter) for setting a gap between a cooling roll and a rubber roll of the present invention.

FIG. 3(a) is a top plan view, FIG. 3(b) is a side view and FIG. 3(c) is a schematic view showing a state in setting the gap of FIG. 3.

FIG. 4 is a schematic view for observing the optical surface defects of a product film.

### BEST MODE FOR CARRYING OUT THE INVENTION

When optical films are produced by a melt-extrusion process, die lines produced through an extrusion die, a flow of resin due to shear of the melt-extruded resin, shrinkage of resin due to cooling and residual retardation due to stress exerted on a film by taking up are produced even if various contrivance and improvement are reduplicated. In order to improve these problems, there has been generally made a trial to transfer a smooth plane by pressing the melted resin between a metal roll and a metal roll or a smooth metal belt and further to dissolve the flow of resin in the extrusion direction and the fluctuations in a resin thickness in the extrusion direction such as a die line by creating the flow of resin in other direction through pressure.

The present inventors have found that by using a cooling roll made of a hard material, i.e., metal or ceramic, and a roll made of a soft material, i.e., a rubber roll, and further by pressing the melt-extruded resin layer via a supporting layer made of a synthetic resin film or the like which is a poor conductor between these rolls, adhesion or close contact between the supporting layer and the extruded resin is enhanced compared with a method of pressing the extruded resin between metal rolls, the rubber roll causes pressure to distribute, and the flow of resin in other direction is easily created and the fluctuations in a thickness are leveled out even though the fluctuations in thickness of the melted resin through a die are generated, and the transfer of a smooth plane of the surface is also good, and die lines disappear and the residual stress due to flow within a die is markedly reduced.

The reason why an effect like the above is attained is assumed to be that a supporting layer made of a synthetic resin film or the like which is a poor conductivity has a thermal insulation property and therefore it becomes flexible with an increase in temperature and has high conformability with the melted resin and a bite of a bank resin becomes more smooth than the metal layer. Further, when the supporting layer is used, a temperature gradient in the thickness direction of the melted resin becomes less and therefore distortion between the front side and the back side of a product film is difficult to occur.

And, the reason why an effect like the above is attained is assumed to be that since the melt-extruded resin layer is carried together with the supporting layer until they reach an appropriate temperature, it is possible to prevent the shrinkage due to cooling and the stress by taking up from being imparted to desired optical films, and thereby it is possible to simultaneously dissolve the fluctuations in thickness such as a die line and the residual retardation generated by a production process.

Further, the present inventors continued to make studies, and consequently they have found that by maintaining an adequate gap between a cooling roll and a rubber roll and supporting this gap with an appropriate pressing force as a backup, as described later, in order to enhance an effect of pressing the melted resin between rolls in the above technology, it is possible to level out the errors in accuracy of mechanical units including the rubber roll and the fluctuations such as an uneven thickness of the melted film by virtue of rubber's elasticity and a pressing force of a backup together with a uniform gap, and thereby it is possible to obtain an optical film further improved in the aspects of the fluctuations in thickness, the smoothness and uniform optical characteristics.

As the thermoplastic resin used in the present invention, a resin which is suitable for producing optical films is selected. For this purpose, it is required that it is a transparent resin and has heat resistance and moisture resistance to an extent that these resistances do not interfere in practice in order to enhance the reliability of, for example, a liquid crystal display unit in which this resin is incorporated. As such a thermoplastic resin, polycarbonate, polysulfone, polyallylate, aromatic polyester and cyclic polyolefin are suitable. Among others, the cyclic polyolefin is low in hygroscopicity and has high heat resistance and excellent optical characteristics, and since it particularly less causes birefringence due to orientation of a molecule when a molecule is oriented, it is suitable for producing the raw material of an optical film.

Cyclic polyolefin has an alicyclic structure on a main chain and/or a side chain. As a alicyclic structure, a cycloalkane structure and a cycloalkene structure can be exemplified, but the cycloalkane structure is suitable for optical uses. As a unit of these alicyclic structures, 5 to 15 carbon atoms are preferred. And a polymer containing the unit having these alicyclic structures in an amount 50% by weight or more is preferable. As such a polymer, there are given norbornene-based polymer, monocyclic cycloolefin-based polymer, cyclic conjugated diene-based polymer, hydrocarbon polymers having a side chain alicyclic structure and hydrogenated compounds thereof. Among these, norbornene-based polymer and hydrogenated compounds thereof, and cyclic conjugated diene-based polymer and hydrogenated compounds thereof are preferred. As a typical resin of these polymer, there can be given ARTON (trade name, produced by JSR Corporation), ZEONEX (trade name, produced by ZEON CORPORATION), ZEONOR (trade name, produced by ZEON CORPORATION) and APEL (trade name, produced by Mitsui Chemicals, Inc.).

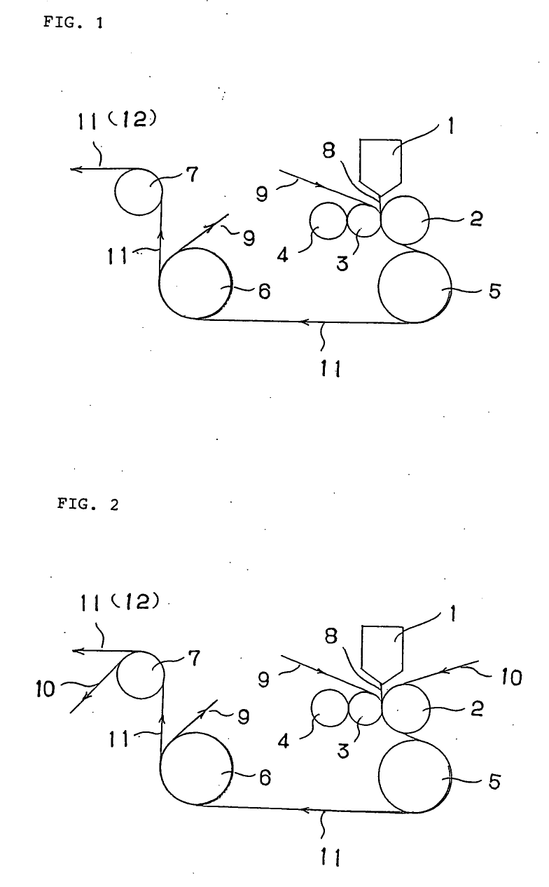

A schematic view for illustrating the method of melt-extruding in the present invention is shown in FIG. 1. In this Figure, the portion of a melted resin 8 extruded in a film through the extrusion die 1 is shown. An extruder may be a single-screw or a twin-screw type, or a melt kneader. The configuration of each screw is appropriately selected and is not particularly limited. Generally, an diameter of the screw is 40 to 150 mm, and an L/D ratio is 20 to 38 and preferably 25 to 34, and a compression ratio is 2.5 to 4.

A method of charging a resin into an extruder is not limited, but by drying and carrying the resin in such a way that the occurrence of resin powder in a hopper becomes as small as possible, and by charging the resin into an extruder at a resin temperature of drying temperature±2° C. or raising temperature to a temperature of 60 to 80% of Tg in the case of resin having high Tg, a residence time in a screw becomes short and a resin film of good quality is easily obtained. Further, it is preferable to reduce an oxygen concentration by purging the inside of a hopper and a melting zone of a cylinder with nitrogen gas.

It is preferred to secure a constant discharge rate per hour through a gear pump after passing the melted resin through a mesh or a porous filter material to remove foreign matters. Then, it is extruded as a melted resin 8 in film form through the extrusion die 1. The extrusion die 1 may be one having a usual configuration, which is used for forming sheets and films. For example, there can be employed dies of a coat hanger type, a straight manifold type and a fishtail type. A clearance of an opening of the extrusion die 1 is selected according to a desired thickness of a sheet or a film, and it is usually about 0.1 to 3 mm.

In FIG. 1, the melted resin 8 extruded into a film through the extrusion die 1 is sandwiched between a cooling roll 2 which is made of metal or ceramic and a supporting layer 9 pressed between the cooling roll 2 and a rubber roll 3. In order to provide a uniform pressure for the entire width of the melted resin 8, the rubber roll 3 is pressed against the side of the cooling roll 2 by a metal backup roll 4 to establish the gap between the rubber roll and the cooling roll. In addition, the metal as a roll material is not particularly limited and for example, publicly known metal such as iron, stainless steel and the like are employed.

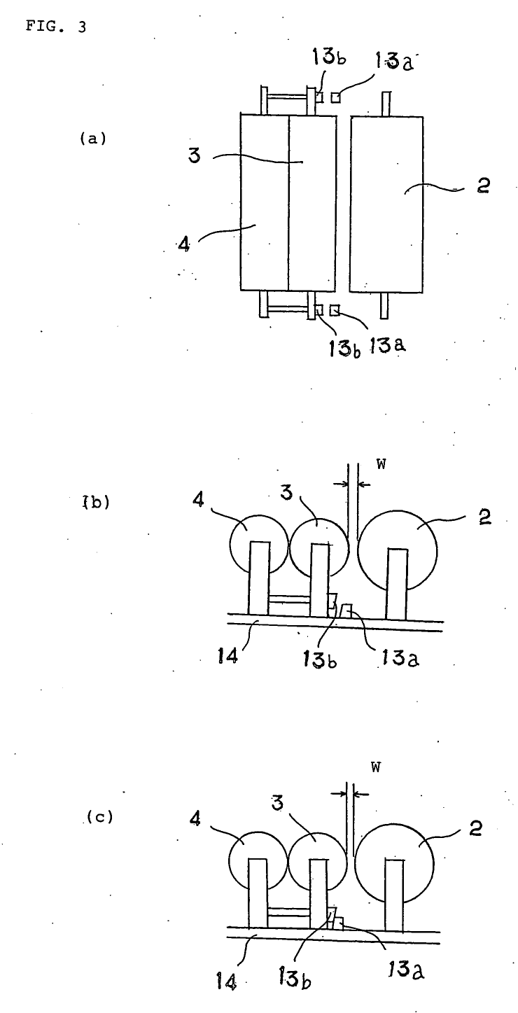

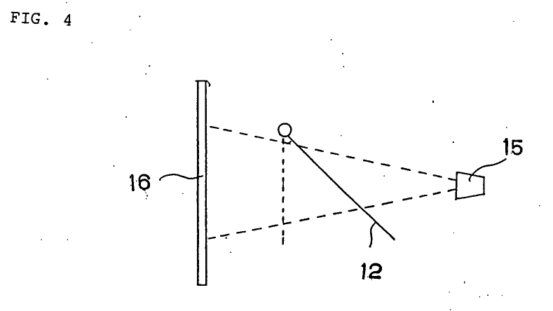

A method of establishing the gap between the cooling roll 2 and the rubber roll 3 is a method of using two stoppers 13 having the same gradient, respectively, referred to as a cotter, as shown in FIG. 3. That is, one stopper 13b is attached to a rotation axis of the cooling roll 2 or the rubber roll 3 (attached to the rubber roll 3 side in this Figure) and the other stopper 13a is installed on a rail 14 and slid on the rail 14 and fixed at a desired position. And, the stoppers 13a, 13b are adapted to finely adjust the gap W between the cooling roll 2 and the rubber roll 3 by sliding on opposite inclined surfaces up or down. And, by these stoppers 13a, 13b, it is possible to prevent the gap W between the cooling roll 2 and the rubber roll 3 from becoming smaller than a certain distance between these rolls. And, a set pressing force presses these rolls through the backup roll 4 so as to maintain the established gap W. The set pressing force is transmitted to the backup roll 4 with an air cylinder (not shown) through an air pressure.

Temperature of the cooling roll 2 is precisely controlled and it is generally proper that this temperature ranges from glass transition temperature of the melted resin 8 +30° C. to glass transition temperature −70° C. The melted resin 8 is carried to the second cooling roll 5 in a state of pseudo-bonding to the supporting layer 9 while being sandwiched between the cooling roll 2 and the supporting layer 9, and pressed against the cooling roll 5 under a certain tension and cooled down to form a formed film 11.

The formed film 11 and the supporting layer 9 are taken up in a state of pseudo-bonding from the second cooling roll 5 to the third cooling roll 6 by a take-up force controlled by the third cooling roll 6, and there the formed film 11 from which the supporting layer 9 was peeled off is sent as a film product 12 to a winding reel (not shown) through a roll 7 and taken up. The respective rolls are operated in a state of being linked or being separately provided with a driving force in such a way that the supporting layer 9 is carried together with the melted resin layer 8 or the formed film 11.

FIG. 2 is a schematic view in the case of arranging the supporting layers 9 and 10 on both sides of the melted resin 8 in film form, that is, on one side contacting with the rubber roll 3 and the other side contacting with the cooling roll 2. This process is operated using a procedure approximately similar to that in the case of arranging the supporting layer on one side in FIG. 1, including temperature conditions of the cooling roll. The respective supporting layers 9 and 10 are peeled off by the cooling roll 6 and the roll 7 and then the formed film 11 is taken up as a film product 12.

The supporting layer pressed between the rolls is preferably a synthetic resin film since it is important that the supporting layer is a poor thermal conductor compared with metals or ceramics. Since there is a possibility that the smoothness of the surface of the supporting layer may be transferred to the surfaces of intended film products, a supporting layer having the surface which is as flat and low in roughness as possible is preferred and a supporting layer having surface roughness characteristics of 0.01 μm or smaller in terms of an average centerline roughness defined in JIS B0601 is preferred. Further, synthetic resin films as the supporting layer must be resistant to the melted resin extruded into a film. Therefore, there can be given films such as polycarbonate, polysulfone, polyether sulfone, polyphenylsulfide, polylmide, etc., biaxially oriented films such as biaxially oriented polyethylene terephthalate, biaxially oriented poly(ethylene naphthalate), etc., which have relatively high heat resistance. Particularly, films comprising the above resins, which are obtained by casting with a solvent, a casting film of triacetyl cellulose and biaxially oriented polyester films are preferred in point of good smoothness. And, the melted resin extruded into a film and the supporting layer are pressed between rolls and carried together. The extruded (melted) resin and the supporting layer may be the same kinds or different kinds as long as they can be peeled and separated after cooling even though they are pseudo-bonded to each other.

A rubber roll to be used for pressing between rolls preferably has a structure in which various rubber-like materials are wound concentrically around the metal core. A thickness of the rubber-like material is appropriately selected, but a thickness of 5 to 15 mm is suitable. When the thickness of the rubber-like material is less than 5 mm, the result become close to the case of using only metal rolls and an effect of pressing between rolls is small, and on the other hand, when it is more than 15 mm, the deformation of rubber is large and a wrinkle of the supporting layer tends to occur. A hardness of the rubber-like material has an influence upon an effect of pressing between rolls, and when the hardness is not 60 or more in terms of a Shore's hardness, the effect is small. When the Shore's hardness is less than 60, an effect of leveling out fluctuations in thickness of the melted resin from the die is small and the residual retardation is large. And, there is less rubber rolls having a Shore's hardness of 100 or more. As the rubber-like material, acrylonitrile butadiene rubber (NBR) is usually employed for laminating the thermoplastic resin and the supporting layer, but it is possible to select from SBR, chloroprene, chlorinated polyethylene, chlorosulfonated polyethylene, polyester elastomer, urethane rubber, silicon rubber and compounds thereof. NBR or silicon rubber is preferred from the viewpoint of an operational temperature.

Optical surface defects of optical films include three kinds of longitudinal streaks due to die lines along the direction of an operation for producing films or uneven thickness, transverse streaks orthogonal to longitudinal streaks due to gear marks and uneven adhesion due to the insufficient adhesion of a film to the cooling roll or the supporting layer.

When a pressing force of one roll against the other roll of the rubber roll and the cooling roll, between which the melted resin layer is pressed, becomes too large, longitudinal streaks are easy to be dissolved but transverse streaks are prone to be produced. When the pressing force becomes too small, the transverse streaks do not occur but the longitudinal streaks cannot be dissolved and this causes uneven adhesion pattern due to inclusion of air. Therefore, the pressing force is preferably within a range of 2.7 to 10.0 kgf/cm in terms of a line pressure and more preferably within a range of 3.0 to 7.0 kgf/cm. The line pressure in this appropriate range is characterized by being extremely lower than line pressures employed to laminates of synthetic resins produced by normally pressing between rolls or lamination of resin onto paper.

In order to melt-laminate the thermoplastic resin on the supporting layer, generally, a gap between a rubber roll and a cooling roll is not set (substantially no gap), and even if the gap is set, it is arbitrarily set. But, in the case of producing optical films of the present invention, setting of the distance of a gap is important. Accordingly, this setting value of the distance of a gap is preferably set within a range of 10% to 90% of the total of a thickness of the supporting layer simultaneously sandwiched between rolls and a thickness of the thermoplastic film to be obtained. When this ratio of the gap to the total thickness is less than 10%, a bank of melted resin is produced at the gap between a cooling roll and a rubber roll and gear marks tend to be produced. On the other hand, when it is more than 90%, not only it becomes hard to dissolve the longitudinal streaks, but also birefringence tends to increase. The ratio of the gap is more preferably 40 to 60%.

The film thickness of the supporting layer is not limited, but when it is too thin, an effect is small and when it is too thick, this tends to interfere with an operation. Accordingly, it is generally preferred that the film thickness ranges from 50 to 200 μm.

The supporting layer may be preheated before it is pressed together with the melted resin between rolls and then supplied. A temperature of preheating is a temperature which is higher than a operational cooling temperature and does not cause the supporting layer to thermally shrink.

The supporting layer and the melted resin layer are carried together until they are cooled, peeled and separated as described above. When both layers varies in kind, it may be hard to carry them together because of insufficient adhesion, but in such a case, it is preferred to enhance an adhesion force by applying surface treatment such as corona discharge treatment, ozone treatment, flame treatment, glow discharge and plasma discharge treatment to the surface to be laminated in order to increase an adhesion force on the supporting layer side.

As an extruded film used as a raw material of various optical films, there is required a film which is free from die lines and has a uniform film thickness. The difference between the maximum value and the minimum value of the film thickness is preferably 5% or less of an average film thickness and more preferably 2% or less of the average film thickness. Surface roughness of a film is preferably 0.01 μm or smaller in terms of an average centerline roughness Ra according to JIS B 0601. The dissolution of die lines is achieved by passing the melted resin through a proper filter to reduce foreign matters and by establishing the extrusion conditions, in which the occurrence of burned resin is low, to reduce die lines from a die and by precisely adjusting a die clearance to say nothing of the internal smoothness of a die extruding the resin into a film and by optimizing operating conditions, in which the melted resin is pressed together the supporting layer between rolls, as describe above.

As an extruded film used as a raw material of various optical films, it is important that the extruded film is free from optical surface defects. As described above, in optical surface defects, there are found broadly three kinds of longitudinal streaks, transverse streaks and uneven adhesion. These optical surface defects can be recognized extremely well even when it is not observed through normal transmitted light, by impinging light in a slanting direction relative to a film and projecting the transmitted light on a vertical plane to observe. These optical surface defects become easy to be observed more and more as an angle of the slanting direction increases, but optical surface defects, which cannot be visually recognized with incident light of an angle of 45 degrees, generally present no problem in practice.

And the optical surface defects become easier to be observed as a light source of the transmitted light to be impinged becomes more bright and they are visually recognized in ease when the differential tint of streak patterns are slanted relative to the incident light.

Further, as an extruded film used as a raw material of various optical films, it is required that the extruded film has little fluctuations and low birefringence. These fluctuations are preferably 5 nm or less in the case of expressing the unit of retardation by nanometer (nm). In order to realize this condition, since a film having smaller retardation is advantageous, for example, in the case of a film thickness of 100 μm, it is better that the retardation is preferably 30 nm or less, more preferably 20 nm or less and furthermore preferably 10 nm or less. For this purpose, it is necessary to select an appropriate resin, further to select an appropriate supporting layer, and to adjust the conditions of pressing between rolls and also to set other operating conditions properly. Such a film having small fluctuations can be adequately attained by pressing the melted resin together with the supporting layer between rolls using a cyclic polyolefin having a low photoelastic coefficient, which is less prone to cause birefringence when a molecule is oriented, and by forming.

Optical films thus obtained can be used with the film affixed to various pressure sensitive adhesives or adhesives as a moisture-resistant protection film of iodine-adsorption oriented polyvinyl alcohol polarizer film. Further, in a touch panel which is provided with a transparent conductive layer on its surface or a plastic substrate which is an alternative to a glass substrate for liquid crystal display, a metal oxide film, for example, ITO (indium tin oxide) film or AZO (zinc oxide doped with aluminum) film can be formed by sputtering or metal vapor deposition.

Further, for the retardation plate, a longitudinally oriented retardation film is obtained by using the above optical films as a raw material and by drawing it in the same direction as the winding direction of the film between two rolls having different circumferential velocities, respectively, at a constant temperature after preheating the above optical film as a raw material. On the other hand, a transversely oriented retardation film is obtained by clipping both sides of the optical film as a raw material with clamps or pins and stretching the film in the direction orthogonal to a running direction while running the film. Similarly, if the film is stretched in both directions of the running direction and the direction orthogonal to this with clamps or pins while running, the film becomes simultaneously biaxially oriented film and a retardation film having retardation in the direction of thickness is obtained. And after drawing the film longitudinally or transversely, the film may be further oriented in either longitudinal or transverse direction as a second stage of orientation. A draw ratio is usually 1.5 to 4. A drawing effect can also be attained by employing rolling press between rolls, which do not cause shrinkage in the film transverse direction, in place of drawing.

The obtained oriented optical film is useful as various optical films.

Hereinafter, the present invention will be described more specifically by way of examples, but the present invention is not limited to these examples.

### EXAMPLE 1

According to a schematic view of FIG. 1, a cyclic polyolefin resin (ARTON D4531 produced by JSR Corporation, glass transition temperature (Tg): 132° C.) was passed through a porous filter with a single-screw having an inner diameter of 65 mm and an L/D ratio of 32 and then it was extruded into a film through an extrusion die 1 of 884 mm in width at a constant discharge rate with a gear pump. As the extrusion die 1, a chokeless die of a coat hanger type was used. Temperature of the melted resin 11 discharged through the extrusion die 1 was 278° C.

As a supporting layer 9, a biaxially oriented polyethylene terephthalate film (O3LF8 produced by Teijin DuPont Films Japan Limited), which has an average film thickness of 75 μm and surface roughness characteristics of 0.005 μm in terms of an average centerline roughness Ra, 0.07 μm in terms of a maximum roughness Rmax and 0.07 μm in terms of a ten-point average roughness Rz, was arranged on the side of a rubber roll 3 and a melted resin in film form was pressed between the rubber roll 3 and a metal cooling roll 2 via the biaxially oriented film under a pressure of 12 kgf/cm² as a face pressure (corresponding to an air cylinder of pressure of 13 kgf/cm², a rubber roll contact face length of 8 mm and a line pressure of 9.5 kgf/cm in Example 6 described later). The cooling roll 2 was maintained at 90° C. The supporting layer 9 and the melted resin layer 8 were carried together to the second cooling roll 5 maintained at 47° C. and then carried to the third cooling roll 6 maintained at 35° C., and there the polyethylene terephthalate film of the supporting layer 9 was peeled off and taken up, and on the other hand a formed film 11 was taken up as a film product 12 via a next roll 7. A process line was operated at a speed of 6 m/min.

Characteristics of the formed film 11 (a film product 12) obtained were observed and measured by the following methods. The results are shown in Table 1.

Die Line:

Parallel rays of light of a halogen lamp of 100 W were impinged to the surface of a sample film in which the direction of a film flow is raised and located in a slanting direction and transmitted rays of light are projected on a screen to observe the streaks of tints of light

Film Thickness:

Film thicknesses of 35 locations with 20-milimeter pitches in the transverse direction of a sample film were measured with a film thickness meter, and an average value and a tolerance between maximum and minimum values were determined.

Surface Roughness Characteristics:

Using a microscope for surface analysis with ultra deep depth VK-8500 manufacture by KEYENCE CORPORATION, 3 test pieces were sampled in the transverse direction of the film from a specimen film having a size of 200 μm×200 μm, and an average centerline roughness Ra, a maximum roughness Rmax and a ten-point average roughness Rz are calculated to determine an average value according to JIS B 0601. A contact surface (rubber roll side) of the supporting layer is assumed to be the front side and the cooling roll side of the supporting layer is assumed to be the back side, and the surface roughness was measured.

Retardation:

Using an automatic birefringence analyzer KOBRA-21ADH, a Nicol polarizer and a Nicol analyzer are placed in parallel and a single wave luminous flux was irradiated to a sample film and retardation was derived from the angle dependence of the intensity of transmitted light in rotating the film one turn around a ray axis.

Measurement wavelength: 590 nm, Sample size 35 mm×35 mm

Samples were taken at five locations in the transverse direction of a sample film, and an average value of 5 locations and a tolerance between maximum and minimum values were determined.

### EXAMPLE 2

A formed film 11 (a film product 12) was produced by following the same procedure as in Example 1 except for changing a film thickness of a biaxially oriented polyethylene terephthalate as a supporting layer from 75 μm in Example 1 to 125 μm, and various characteristics were measured. The results are shown in Table 1.

### EXAMPLE 3

A formed film 11 (a film product 12) was obtained by following the same procedure as in Example 1 except that one supporting layer 9 was arranged on the side of a rubber roll 3 and the other supporting layer 10 was arranged also on the side of a cooling roll 2 and a melted resin layer 8 was pressed through the supporting layers on both side between rolls, and various characteristics were measured. The results are shown in Table 1.

### EXAMPLE 4

A formed film 11 (a film product 12) was obtained by following the same procedure as in Example 1 except that a process line speed 6 m/min in Example 1 was changed to 12 m/min and in response to this speed, a discharge rate was adjusted so as to have the approximately same film thickness as in Example 1 to extrude a melted resin. The various characteristics of this film are shown in Table 1.

### COMPARATIVE EXAMPLE 1

Space between the rubber roll 3 and the cooling roll 2 in Example 1 was thoroughly freed and the melted resin layer 8 in film form was extruded so as to contact with a top portion of the cooling roll 2 and passed along the same path line as in Example 1 without using the supporting layer 9 and without pressing the melted resin layer between this roll and the rubber roll 3 to obtain a formed film 11 (a film product 12). Various characteristics of the obtained film are shown in Table 1.

TABLE 1

| | | | | | | Comparative |
|---|---|---|---|---|---|---|
| | | Example 1 | Example 2 | Example 3 | Example 4 | Example 1 |
| Forming method | | Pressed by | Pressed by one | Pressed by | Pressed by | No supportingn |
| | | one side | side supporting | both-side | one side | layer and no |
| | | supporting | layer | supporting | supporting | pressing |
| | | layer | | layers | laye | |
| Supporting layer (μm) | | 75 | 125 | 75 × 2 | 75 | — |
| Operation speed (m/min) | | 6 | 6 | 6 | 12 | 6 |
| Film thickness (μm) | | | | | | |
| Average | | 101 | 97 | 99 | 98 | 98 |
| Maximum-minimum | | 5 | 3 | 3 | 4 | 11 |
| Surface | Average roughness | | | | | |
| roughness | Ra | | | | | |
| (μm) | (front) | 0.006 | 0.005 | 0.005 | 0.006 | 0.007 |
| | (back) | 0.006 | 0.005 | 0.005 | 0.006 | 0.007 |
| | Maximum roughness | | | | | |
| | Rmax | | | | | |
| | (front) | 0.06 | 0.07 | 0.06 | 0.08 | 0.15 |
| | (back) | 0.15 | 0.08 | 0.06 | 0.08 | 0.12 |
| | 10-point average | | | | | |
| | roughness Rz | | | | | |
| | (front) | 0.05 | 0.05 | 0.05 | 0.06 | 0.11 |
| | (back) | 0.10 | 0.07 | 0.05 | 0.08 | 0.08 |

| | | | | | |
|---|---|---|---|---|---|
| Appearance (visually) | Die lines | Die lines are | Die lines | Die lines | Die lines are |
| | are hardly | very difficult | are not | are hardly | clearly |
| | recognized | to be recognized | recognized | recognized | recognized |
| Retardation (nm) | | | | | |
| Average | 3 | 3 | 2 | 4 | 35 |
| Maximum-minimum | 2 | 2 | 2 | 3 | 27 |

As is apparent from Table 1, it is found that as for the film formed by pressing the melted resin layer together with the supporting layer between rolls, a film having the surface roughness characteristics close to that of the supporting layer is obtained and die lines of longitudinal streaks can hardly be visually recognized. Further, it is found that the retardation is extremely reduced compared with the extruded film (Comparative Example 1) in which the supporting layer is not used and pressing between rolls were not performed. On this reduction in the retardation, pressing the resin layer together with two supporting layer on opposite sides of the resin layer between rolls, as described in Example 3, has a larger effect, but even pressing the resin layer together with the supporting layer on one side of the resin layer between rolls, as described in Examples 1, 2 and 4, has a sufficient effect. And, a film thickness of the supporting layer does not have much effect on the retardation and an operation speed also does not have much effect on the retardation.

### EXAMPLE 5

Polycarbonate (Panlite L-1225ZE produced by TEIJIN LTD., Tg: 145° C.) was extruded into a melted resin layer 8 in film form in place of the cyclic polyolefin resin of Example 1 using the same apparatus as in Example 1. Temperature of the extruded resin was 280° C.

A formed film 11 (a film product 12) was obtained by following the same procedure as in Example 1 except that as the supporting layer 9 for pressing the melted resin layer 8, a film of 100 μm in thickness, comprising polycarbonate produced by solution casting was used. Since the solution casting film of the supporting layer and the melt-extruded film were pseudo-bonded to each other, biaxially oriented polyethylene terephthalate was inserted into an initial portion of the operation as a peeling guide and pressed, and thereby this portion became a peeling point and a film can be peeled at the same location as in Example 1. Characteristic values of the formed film 11 (a film product 12) obtained are shown in Table 2.

### COMPARATIVE EXAMPLE 2

Characteristic values of the polycarbonate film produced by solution casting used in Example 5 are shown together in Table 2.

TABLE 2

| | | | Comparative |
|---|---|---|---|
| | | Example 5 | Example 2 |
| Forming method | | Pressed by one side | Solution |
| | | supporting layer | cast film |
| Supporting layer (μm) | | Solution cast film | — |
| | | 100 | |
| Operation speed (m/min) | | 6 | — |
| Film thickness (μm) | | | |
| Average | | 98 | 102 |
| Maximum-minimum | | 6 | 3 |
| Surface | Average | | |
| roughness | roughness Ra | | |
| (μm) | (front) | 0.008 | 0.008 |
| | (back) | 0.007 | 0.007 |
| | Maximum | | |
| | roughness Rmax | | |
| | (front) | 0.11 | 0.1 |
| | (back) | 0.13 | 0.11 |
| | 10-point average | | |
| | roughness Rz | | |
| | (front) | 0.08 | 0.07 |
| | (back) | 0.07 | 0.08 |

| | | |
|---|---|---|
| Appearance (visually) | Die lines are not | Die lines are |
| | recognized | not recognized |
| Retardation (nm) | | |
| Average | 25 | 18 |
| Maximum-minimum | 6 | 5 |

As is apparent from Table 2, by using the film obtained by solution casting as a supporting layer and pressing the melted resin layer through this supporting layer between rolls to form a film, the surface roughness characteristics of the formed film 11 (a film product 12) obtained becomes close to the surface property of the solution casting film and the occurrence of die lines can be prevented. Further, as for retardation, by pressing similarly, there is obtained a film having the retardation close to that of the solution casting film.

### EXAMPLE 6

(Method of Melt-Extruding Resin)

A melted resin was extruded by following the same procedure as in Example 1 except that temperature of the melted resin 8 discharged through the extrusion die 1 was 267° C.

(Supporting Layer and Method of Pressing Between Rolls)

As a supporting layer 9, a biaxially oriented polyethylene terephthalate film (O3LF8 produced by Teijin DuPont Films Japan Limited), which has an average film thickness of 125 μm and surface roughness characteristics, defined in JIS B0601, of 0.005 μm in terms of an average centerline roughness Ra, 0.07 μm in terms of a maximum roughness Rmax and 0.07 μm in terms of a ten-point average roughness Rz, was arranged on the side of a rubber roll 3 and a melted resin was pressed between a metal (steel) cooling roll 2 maintained at 90° C. and the rubber roll 3 of 850 mm in length, which was obtained by winding an acrylonitrile butadiene rubber (NBR) having a Shore's hardness of 90 around the metal (steel) core in a thickness of 6.5 mm. Since a stopper was positioned in such a way that a gap between a cooling roll and a rubber roll is 110 μm, a ratio of the gap between a cooling roll and a rubber roll to the total thickness of the supporting layer and the product film is 48.9% [110 μm/(125 μm+100 μm)×100]. And, as for a pressing force against the rubber roll 3 through a backup roll 4, a rubber roll line pressure was 3.67 kgf/cm since the rubber roll was pressed against the cooling roll by pushing both ends of the rubber roll with two air cylinders 3.15 cm in radius using 5 kgf/cm² of air pressure.

(Method of Cooling and Taking Up Film)

A formed film was obtained by following the same procedure as in Example 1.

(Method of Observing and Measuring Film Chharacteristics)

The obtained film 11 (a film product 12) exhibited the surface roughness characteristics close to those of the supporting layer. And measurement of the film thickness and the retardation is performed according to the same procedure as in Example 1. Characteristics of the optical surface defects were observed and measured by the following methods. The results are shown in Table 3.

Optical Surface Defects:

As illustrated in FIG. 4, by rays of light from a point light source of a xenon lamp of 150 W in which the illumination was greatly increased compared with Examples 1 to 6 as a light source 15, evaluation of longitudinal streaks and transverse streaks was made clear. In the case of observing the longitudinal streaks, the flow direction of a film product 12 is raised and light was impinged at an angle of 45 degrees to the film product and transmitted light was projected on a screen 16 on the rear side to observe the streaks. In the case of observing the transverse streaks, the streaks was observed by placing a film product transversely, and the uneven adhesion pattern was observed in both cases. The results of observation were rated according to the following criteria.

Clear streak patterns and unevenness are present: point 0

Faint streak patterns and unevenness are present: point 1

A little streak patterns and unevenness are present: point 2

Streak patterns and unevenness cannot be recognized: point 3

### EXAMPLE 7

A film was prepared by following the same procedure as in Example 6 except that a ratio of the gap between a cooling roll and a rubber roll was set at 13.3%, and its characteristic values are shown in Table 3.

### EXAMPLE 8

A film was prepared by following the same procedure as in Example 6 except that a ratio of the gap between a cooling roll and a rubber roll was set at 88.9%, and its characteristic values are shown in Table 3.

### EXAMPLES 9 AND 10

A film was prepared by following the same procedure as in Example 6 except that a ratio of the gap between a cooling roll and a rubber roll was set at 0% (the cooling roll and the rubber roll directly contacting with each other) (Example 9) and a film was prepared by following the same procedure as in Example 1 except that a ratio of the gap was set at 100% (the total 225 μm of 125 μm of the supporting layer thickness and 100 μm of the product film thickness) (Example 10), and characteristic values of both films obtained are shown in Table 3.

TABLE 3

| | Example 6 | Example 7 | Example 8 | Example 9 | Example 10 |
|---|---|---|---|---|---|
| Gap between a cooling roll | 110 | 30 | 200 | 0 | 225 |
| and a rubber roll (μm) | | | | | |
| Gap ratio (%) | 48.9 | 13.3 | 88.9 | 0 | 100 |
| Pressing force (air | 5 | 5 | 5 | 5 | 5 |
| pressure) (kgf/cm²) | | | | | |
| Rubber roll line | 3.67 | 3.67 | 3.67 | 3.67 | 3.67 |
| pressure (kgf/cm) | | | | | |
| Film thickness (μm) | | | | | |
| Average | 99 | 99 | 100 | 100 | 101 |
| Maximum-minimum | 2 | 3 | 3 | 3 | 5 |
| Retardation (nm) | | | | | |
| Average | 2 | 2 | 3 | 3 | 4 |
| Maximum-minimum | 2 | 2 | 3 | 3 | 4 |
| Optical surface defects | | | | | |
| Longitudinal streaks | 3 | 3 | 2 | 3 | 1 |
| Transverse streaks | 3 | 2 | 3 | 0 | 3 |
| Uneven adhesion patterns | 3 | 3 | 3 | 3 | 0 |

As is apparent from Table 3, it is found that in the gap between a cooling roll and a rubber, there is an appropriate range within which the optical surface defects are minimized. That is, when this ratio of the gap is within a range of 10% to 90%, an excellent film having smaller fluctuations in film thickness and retardation can be obtained.

### EXAMPLE 11

A film was prepared by following the same procedure as in Example 6 except for changing a rubber roll line pressure to 5.87 kgf/cm by elevating an air pressure to 8 kgf/cm², and characteristic values of the obtained film are shown in Table 4.

### EXAMPLE 12

A film was prepared by following the same procedure as in Example 6 except for changing a rubber roll line pressure to 8.8 kgf/cm by elevating an air pressure to 12 kgf/cm², and characteristic values of the obtained film are shown in Table 4.

### EXAMPLES 13 AND 14

Each film was prepared by following the same procedure as in Example 1 except for changing a rubber roll line pressure to 2.2 kgf/cm by changing an air pressure to 3 kgf/cm² (Example 13) and changing a rubber roll line pressure to 14.67 kgf/cm by changing an air pressure to 20 kgf/cm² (Example 14), and characteristic values of the obtained films are shown in Table 4.

TABLE 4

| | Example 11 | Example 12 | Example 13 | Example 14 |
|---|---|---|---|---|
| Gap between a cooling roll and a rubber roll (μm) | 110 | 110 | 110 | 110 |
| Gap ratio (%) | 48.9 | 48.9 | 48.9 | 48.9 |
| Pressing force (air pressure) (kgf/cm²) | 8 | 12 | 3 | 20 |
| Rubber roll line pressure (kgf/cm) | 5.87 | 8.8 | 2.2 | 14.67 |
| Film thickness (μm) | | | | |
| Average | 100 | 99 | 100 | 99 |
| Maximum-minimum | 2 | 3 | 4 | 2 |
| Retardation (nm) | | | | |
| Average | 2 | 2 | 4 | 3 |
| Maximum-minimum | 2 | 2 | 3 | 2 |
| Optical surface defects | | | | |
| Longitudinal streaks | 3 | 3 | 1 | 3 |
| Transverse streaks | 3 | 2 | 3 | 0 |
| Uneven adhesion patterns | 3 | 3 | 1 | 3 |

From Tables 4 and 3, it is found that under an appropriate pressing force, a film having small fluctuations in film thickness and retardation and low optical surface defects can be obtained. That is, when the pressing force is within a range of 2.7 to 10.0 kgf/cm, it is possible to obtain excellent films having smaller fluctuations in film thickness and in retardation and lower optical surface defects.

### INDUSTRIAL APPLICABILITY

As described above, the method of present invention in which the resin melt-extruded into a film is pressed together with the supporting layer which is a poor conductivity between soft and hard rolls, that is, between a roll made of metal or ceramic and a rubber roll, can produce films suitable for optical uses, which dissolve die lines and have small retardation and small fluctuations in retardation. In this case, by setting the distance of a gap between these rolls between 10% and 90% of the total thickness of a supporting layer and the film, installing a stopper on either the cooling roll or the rubber roll in such a way that these two rolls does not come within this distance of each other, and applying a pressing force of 2.7 to 10.0 kgf/cm to the roll on which the stopper has been provided to produce a film, films suitable for optical uses, which dissolve die lines and gear marks more effectively and have smaller retardation and smaller fluctuations in retardation and lower optical surface defects, can be produced.

1. A method for producing optical films comprising the steps of:
melt-extruding a thermoplastic resin into a film through a die of an extruder,
pressing the melt-extruded thermoplastic resin layer together with a supporting layer between a cooling roll which is made of metal or ceramic and a rubber roll which is pressed against the cooling roll and rolled in the same circumferential direction,
carrying the thermoplastic resin layer together with the supporting layer under taking off tension until the thermoplastic resin layer is cooled down, and
peeling and separating the supporting layer from the thermoplastic resin layer to obtain a thermoplastic resin film.

2. The method for producing optical films according to claim 1, wherein the distance of a gap between the cooling roll and the rubber roll is set so as to be any value between 10% and 90% of the total thickness of the supporting layer and the film, and a stopper is installed on either the cooling roll or the rubber roll in such a way that these two rolls does not come within a distance of this value of each other, and the thermoplastic resin layer is pressed between the rolls by applying a pressing force of 2.7 to 10.0 kgf/cm to the roll on which the stopper is provided.

3. The method for producing the optical films according to claim 1, wherein the supporting layer is a synthetic resin film.

4. The method for producing optical films according to claim 1, wherein the rubber roll is a roll in which a rubber-like material having a surface hardness of 60 or more is wound around a metal core in a thickness of 5 to 15 mm.

5. The method for producing optical films according to claim 1, wherein the thermoplastic resin layer is pressed through the supporting layer between rolls by arranging the supporting layer on the side contacting with a rubber roll.

6. The method for producing optical films according to claim 1, wherein the thermoplastic resin layer is pressed through the supporting layers between rolls by arranging the supporting layers on one side contacting with a rubber roll and on the other side the supporting layer contacting with a cooling roll.

7. The method for producing optical films according to claim 1, wherein the thermoplastic resin is a cyclic polyolefin resin.

8. The method for producing optical films according to claim 1, wherein the supporting layer comprises a biaxially oriented polyethylene terephthalate.

9. The method for producing optical films according to claim 1, wherein optical films obtained by the method for producing according to claim 1 have the smoothness of 0.01 μm or less in terms of an average roughness Ra and a birefringence of 30 nm or less in terms of retardation.

10. The method for producing according to claim 1, wherein optical films have a retardation of 20 nm or less, and the streaks or the pattern of tints are not substantially visually recognized when transmitted light of light impinged at an angle of 45 degrees to a film is projected on a vertical plane.
